(19) United States
(12) Patent Application Publication
(10) Pub. No.: US 2021/0201298 A1
(43) Pub. Date: Jul. 1, 2021

(54) INTEGRATION OF TRANSACTION PROCESSOR SYSTEM IDENTIFIERS WITH DIGITAL ACCOUNT PROVIDERS

(71) Applicant: PayPal, Inc., San Jose, CA (US)

(72) Inventors: Sripaul Chidambaram Asokan, Santa Clara, CA (US); Venkatraman Suresh, San Jose, CA (US)

(21) Appl. No.: 16/730,922

(22) Filed: Dec. 30, 2019

(51) Int. Cl. G06Q 20/36

(52) U.S. Cl. CPC G06Q 20/3676

(57) ABSTRACT

There are provided systems and methods for integration of transaction processor system identifiers with digital account providers. A user may utilize a transaction processor to process a transaction with a merchant. When processing the transaction, the user may navigate to a checkout page, where the transaction processor may utilize a shared identifier and API integrations to retrieve information from other wallet providers associated with the user's digital wallet balances with those other wallet providers. The user may request use of those funds during the checkout page, which may cause a payout request for those funds to be issued by the transaction processor to one or more of the wallet providers to provide the funds to the transaction processor. The transaction processor may also use an account of the other wallet provider(s) to provide the funds immediately to the user, which may then use those funds on the checkout page.

### TECHNICAL FIELD

The present application generally relates to linking digital wallets between different platforms and more particularly to integrating different systems for digital wallets utilizing shared identifiers.

### BACKGROUND

Users may utilize online merchant marketplaces and service providers for browsing and shopping for products and/or services, as well as purchasing different items from these online platforms. When processing transactions on the platform, users may utilize account and digital wallet services of the platform, which may allow users to store and utilize value and funds with the service provider. For example, a digital wallet may be used to send and receive payments with the service provider and/or other users of the service provider's platform. However, when funds are stored to a digital wallet with a particular service provider, those funds are typically only able to be used with that service provider. In order to utilize the funds with a different service provider and/or on a different platform (e.g., to purchase different items and/or interact with different merchants), the user is required to request withdrawal and placement of those funds into a different account, such as a bank account of the user. This may take a significant amount of time and therefore those funds stored in different digital wallets are not always immediately accessible to the user.

### BRIEF DESCRIPTION OF THE DRAWINGS

FIG. 1 is a block diagram of a networked system suitable for implementing the processes described herein, according to an embodiment;

FIG. 2 is an exemplary data processing flow between different platforms for integration of transaction processor system identifiers with digital account providers, according to an embodiment;

FIG. 3 is an exemplary system environment where a client device interacts with a merchant device and service provider server for integration of transaction processor system identifiers with digital account providers, according to an embodiment;

FIG. 4 is a flowchart of an exemplary process for integration of transaction processor system identifiers with digital account providers, according to an embodiment; and

FIG. 5 is a block diagram of a computer system suitable for implementing one or more components in FIG. 1, according to an embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

Provided are methods utilized for integration of transaction processor system identifiers with digital account providers. Systems suitable for practicing methods of the present disclosure are also provided.

A service provider, such as an online transaction processor, may provide digital wallet services to users through an account of the user with the service provider. Users may utilize these accounts and digital wallets to process a transaction and pay for goods, services, or other items available from merchants. Different service providers may each provide their own separate digital wallets, where users may have funds spread out across multiple platforms and digital wallets. Thus, when past users wish to pay for an item using a digital wallet, the users are typically required to request transfers between digital wallets and financial institutions, which may take significant amounts of time. For example, a bank may collect or accrue payout requests, which require fees from partner service providers, by users over a time period, and then may send out these payout requests together. These push type requests push data and the virtual funds from one service provider to another service provider. In contrast, a service provider providing a universal digital wallet to a user may instead utilize integrations with exposed application programming interfaces (APIs) of other digital wallet providers (e.g., those external to the service provider, which may correspond to separate platforms, service providers, servers, or other online entities). Using the integrations, a shared or universal identifier may be used to determine funds in the external digital wallet with the external wallet provider. Thereafter, the service provider may transfer an amount of those funds (or corresponding requested amount) into the universal digital wallet for the user from a corresponding account of the external wallet provider. Using the shared identifier, the service provider may simultaneously request those funds in the external digital wallet from the external wallet provider. These may occur substantially in real-time and/or at the same time using the exposed API of the external wallet provider and the shared identifier so that those funds are removed from the external digital wallet. Thus, the user may immediately use those funds transferred into their universal digital wallet while the service provider awaits the payout request processing.

For example, a user may wish to process a purchase of the items via the checkout interface of a service provider (e.g., online transaction processor) that provides a digital wallet through an account of the user. Selection of a fund balance request and/or payment request may initiate the process to complete the purchase using digital funds stored or held by an external digital wallet with another external wallet provider (e.g., a separate service provider platform). A user may pay for one or more transactions using their digital wallet or other account with the online service provider (e.g., PayPal®). An account with a service provider may be established by providing account details, such as login data, password (or other authentication credential, such as a biometric fingerprint, retinal scan, etc.), and other account creation details. The account creation details may include identification information to establish the account, such as personal information for a user, business or merchant information for an entity, or other types of identification information including a name, address, and/or other information. The user may also be required to provide financial information, including payment card (e.g., credit/debit card) information, bank account information, gift card information, benefits/incentives, and/or funding source data, which may be used to process transactions after identity confirmation. The online payment provider may provide digital wallet services, which may offer financial services to send, store, and receive money, process financial instruments, and/or provide transaction histories, including tokenization of digital wallet data for transaction processing. The application or website of the service provider, such as PayPal® or other online payment provider, may provide payments and the other transaction processing services. In order to pay for the transaction (e.g., a transfer or payment to another user, merchant, or other entity), the user may provide user financial or funding source information (including funds with other wallet providers) or may login to an account with the service provider through authentication information and process the transaction using the account. A payment may then be issued to the other party using the funds in the account, and a receipt may be issued using the digital wallet of the account.

Once the account is created and digital wallet established, a user may wish to utilize the digital wallet to pay for a transaction with a merchant, which may correspond to an online or in-store electronic transaction for one or more items. The user may utilize their computing device, such as a mobile phone, desktop computer, tablet, or other device to select items for purchase and/or interface with a merchant device to generate transaction data for a transaction having one or more items for purchase. Once the order is generated, the user may request a checkout and processing of the transaction using the digital wallet of the service provider. The service provider and/or merchant system may redirect an interface of an application on the user's device (e.g., a webpage in a browser application or an interface of a resident dedicated application) to a checkout page or interface of the service provider. On the checkout page or interface, the user may be required to authenticate the account, such as by entering a login name, address, password, and/or PIN. In some embodiments, the service provider may provide a one-touch or “stay logged on” transaction processing operation where the user is not required to always login to the user's account. This checkout page may further include transaction data and an approval process for the transaction. Moreover, once the account is accessed and corresponding digital wallet is determined (e.g., the financial instruments and funds for the account), those payment instruments may be displayed on the checkout interface so that the user may select one or more funding sources for use with the transaction. This may include linked digital wallets with other external service providers that provide digital wallet services for these external digital wallets of the user with the other external service providers. In some embodiments, the user may designate such external digital wallets, for example, by providing an identifier for the external digital wallets and/or external wallet providers. However, the service provider for the user's digital wallet being used with the checkout may also identify and determine these external digital wallets using a shared identifier, as discussed herein.

When selecting funding sources for payment of the transaction, the user may wish to pay for the transaction using the funds stored to one or more of the external digital wallets. The checkout interface may display the amount of funds in an external digital wallet if the information is available to the service provider. However, if the information is not available and/or needs to be updated, the service provider may execute an API to interface with one or more exposed APIs of the external wallet provider to exchange API calls. The API(s) exposed by the external wallet provider to the service provider may allow the service provider to transmit or make API calls to the external wallet provider, where the service provider may determine external digital wallet data for the external digital wallet. This data may include the funds stored to the digital wallet, including held payment amounts, virtual cash or funds, restrictions for use of the funds, and/or virtual currency (including service provider specific virtual currencies). The data for the external digital wallet may be determined using an identifier for the external digital wallet, where the identifier is shared between the service provider and the external wallet provider. For example, a payment identifier for the user's digital wallet with the service provider (e.g., the digital wallet used with the checkout interface and process) may be shared with the external wallet provider for the external digital wallet of the user. The identifier may also correspond to a name, address, username, phone number, email address, or other identifier that may be shared between different digital wallets and allow for identification of the correct digital wallet of the user with the external wallet provider. Thus, the identifier may be universal or shared between multiple different platforms. Once the data for the external digital wallet is determined using the shared identifier and exposed API, the data (e.g., the amount of the virtual funds in the external digital wallet) may be displayed through the checkout interface with the digital wallet of the user.

The checkout interface may display additional funds available to the user and/or restrictions to process the transaction from the external digital wallet of the user with the external wallet provider. The checkout interface may be refreshed to display the amount(s) available from the external digital wallet(s) of the user. This may occur automatically so that the user is not required to manually reload or refresh the checkout webpage or interface or navigate to another interface. Thus, the interface may be automatically refreshed to display these amounts without requiring further user input. In some embodiments, the data for the external digital wallet may be automatically obtained by the service provider as described above when the user navigates to the checkout interface during electronic transaction processing. However, in other embodiments, the data for the external digital wallet may only be fetched or retrieved on request by the user. Additionally, when the user wishes to use some or all of the amount from the external digital wallet to process the transaction, the service provider may determine an internal account of the external wallet provider with the service provider. For example, the external wallet provider may be a client, user, customer, and/or partner of the service provider such that they have established an account with the service provider that has payment instruments, financial accounts, and/or funds in the account. The service provider may then withdraw the amount (or another amount specified by the user in the checkout interface) of the funds from the external digital wallet from the internal account of the external wallet provider with the service provider. The amount from that internal account may then be provided, transferred to, or deposited in the digital wallet of the user with the service provider. Thus, the amount may be immediately available to the user through the digital wallet with the service provider for use with the transaction in the checkout interface.

Additionally, at the same or within a time as providing the amount from the internal account of the external wallet provider to the digital wallet of the user, the service provider may request the amount of the virtual funds from the external digital wallet of the user. In this regard, using the exposed API(s) of the external wallet provider, the service provider may request or issue an API call requesting that the amount of the funds in the external digital wallet be transferred from the external wallet provider to the service provider. This request may be processed using the financial institutions and transfer processes for the funds, which may cause the funds to exit the external wallet provider and be provided to the service provider. This may occur substantially in real-time with the transferring of the amount of the funds to the digital wallet of the user with the service provider. This allows the external wallet provider to be informed of the transferring of the amount out of the internal account of the external wallet provider with the service provider so that external wallet provider updates their database and records to reflect the withdrawal of the amount of the funds in the external digital wallet by the user. The external digital wallet may then show an updated balance based on the amount of the funds that have been transferred at the same or similar time that the checkout interface and digital wallet of the user with the service provider is updated with the funds provided from the internal account of the external wallet provider with the service provider. Thus, the operation may act as a pull operation or process where the service provider may pull the funds from the external digital wallet through the API integrations and universal identifier for the digital wallets.

The user may then be provided the funds to be utilized with the transaction in the checkout interface. The user may request electronic transaction processing for the transaction using some or all of the funds from the external digital wallet. The transaction may be processed through the checkout interface where a payment is issued to an account of the corresponding merchant for the checkout interface from the digital wallet of the user. The payment may include some or all of the funds transferred into the account based on the external digital wallet, as well as additional funds and/or a funding instrument (e.g., payment card, such as a debit or credit card) with the digital wallet. A transaction history, such as a receipt, may be issued for processing the transaction, which may not the amount of the funds used from the external digital wallet. In some embodiments, the funds from the external digital wallet may also correspond to a digital or virtual currency, such as “points” or rewards/benefits with one or more service providers. These virtual currencies may similarly be transferred, redeemed, and/or use with merchants that accept those currencies. Thus, by utilizing real-time data exchange through the exposed APIs when transferring funds internally and requesting funds from external wallet providers, the service provider system may prevent abuse or fraud where the funds in different digital wallets may be incorrectly accounted for. Moreover, by utilizing a universal shared identifier that may be used to determine data through one or more API integrations, the service provider may provide immediate usage of funds in separate and different digital wallets through a convenient interface and process for the user's account and digital wallet.

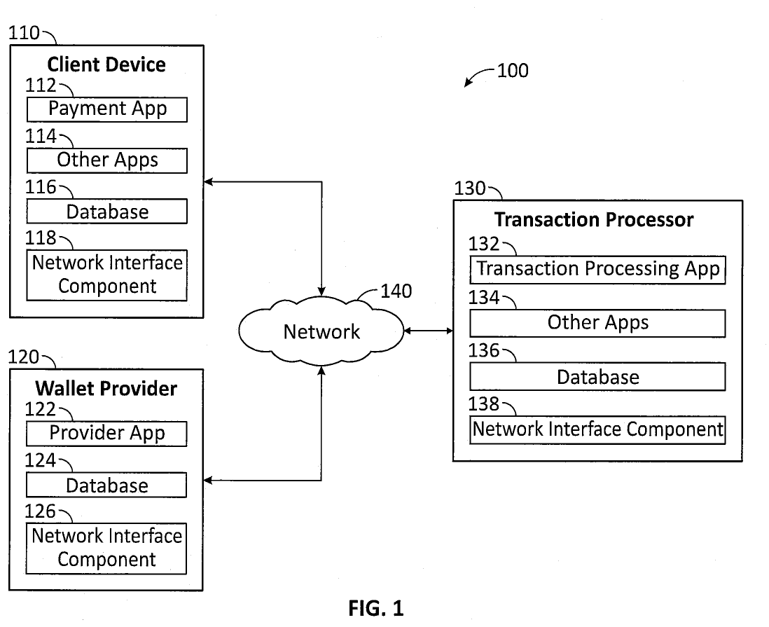

FIG. 1 is a block diagram of a networked system 100 suitable for implementing the processes described herein, according to an embodiment. As shown, system 100 may comprise or implement a plurality of devices, servers, and/or software components that operate to perform various methodologies in accordance with the described embodiments. Exemplary devices and servers may include device, stand-alone, and enterprise-class servers, operating an OS such as a MICROSOFT® OS, a UNIX® OS, a LINUX® OS, or other suitable device and/or server based OS. It can be appreciated that the devices and/or servers illustrated in FIG. 1 may be deployed in other ways and that the operations performed and/or the services provided by such devices and/or servers may be combined or separated for a given embodiment and may be performed by a greater number or fewer number of devices and/or servers. One or more devices and/or servers may be operated and/or maintained by the same or different entities.

System 100 includes a client device 110, a wallet provider 120, and a transaction processor 130 in communication over a network 140. Client device 110 may be utilized by a user to interact with a merchant through an online merchant marketplace or physical merchant device (e.g., a point-of-sale (POS) device at a merchant location. Client device 110 may be used to generate a transaction, where client device 110 may then navigate to a checkout webpage or interface to process the transaction. Thereafter, the user may request payment of the transaction based on funds with a digital wallet of wallet provider 120. Transaction processor 130 may interface with wallet provider 120 using a shared identifier to determine an amount of the funds in the digital wallet and may utilize an internal account of wallet provider 120 to provide the funds to the user during the checkout page on client device 110. Transaction processor 130 may further request transfer of the funds using the identifier so that the external digital wallet is updated to reflect the fund transfer.

Client device 110, wallet provider 120, and transaction processor 130 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 140.

Client device 110 may be implemented as a communication device that may utilize appropriate hardware and software configured for wired and/or wireless communication with transaction processor 130. For example, in one embodiment, client device 110 may be implemented as a personal computer (PC), a smart phone, laptop/tablet computer, wristwatch with appropriate computer hardware resources, eyeglasses with appropriate computer hardware (e.g. GOOGLE GLASS®), other type of wearable computing device, implantable communication devices, and/or other types of computing devices capable of transmitting and/or receiving data, such as an IPAD® from APPLE®. Although only one device is shown, a plurality of user and/or vehicle devices may function similarly and/or be connected to provide the functionalities described herein.

Client device 110 of FIG. 1 contains a payment application 112, other applications 114, a database 116, and a network interface component 118. Payment application 112 and other applications 114 may correspond to executable processes, procedures, and/or applications with associated hardware. In other embodiments, client device 110 may include additional or different modules having specialized hardware and/or software as required.

Payment application 112 may correspond to one or more processes to execute software modules and associated components of client device 110 to process electronic transactions over a network with one or more other services and/or users, including browsing items on an online merchant marketplace for a merchant and utilizing funds from a digital wallet with wallet provider 120. In this regard, payment application 112 may correspond to specialized hardware and/or software utilized by a user of client device 110 that may be used to access a website or an interface of a marketplace or other sales platform that allows client device 110 to browse item data for items for sale, or may be used to interact with a merchant device to provide payment for a transaction. Payment application 112 may further be utilized enter or receive transaction data for a transaction, provide an account, financial data, or a digital token used to pay for the transaction data, and instruct transaction processor 130 to perform transaction processing. Payment application 112 may utilize one or more user interfaces, such as graphical user interfaces presented using an output display device of client device 110, to enable the user associated with client device 110 to enter and/or view interface data, where the interface data may include a checkout webpage or interface to process the transaction, as well as use digital wallet funds held by wallet provider 120.

In some embodiments, payment application 112 may display data for a marketplace, including item data for browsable items for sale from wallet provider 120, through an application interface, or may display a transaction for processing. Thus, an interface of payment application 112 may include transaction data as well as a checkout process for transaction processing. During transaction processing, payment application 112 may be utilized to select payment instrument(s) for use in providing payment for a purchase transaction, transfer, or other financial process. As discussed herein, payment application 112 may utilize user financial information, such as credit card data, bank account data, or other funding source data, which may be stored with a digital wallet of the user with transaction processor 130. Additionally, payment application 112 may utilize funds in a digital wallet associated with wallet provider 120, which may be displayed in the checkout interface. Payment application 112 may request display of these funds and may be automatically refreshed to display the funds when transaction processor 130 provides data for the funds to client device 110. Payment application 112 may also be used to receive a receipt or other information based on transaction processing. In various embodiments, payment application 112 may correspond to a general browser application configured to retrieve, present, and communicate information over the Internet (e.g., utilize resources on the World Wide Web) or a private network. For example, payment application 112 may provide a web browser, which may send and receive information over network 140, including retrieving website information (e.g., a website for transaction processor 130), presenting the website information to the user, and/or communicating information to the website, including payment information for a transaction processed through transaction processor 130. However, in other embodiments, payment application 112 may include a dedicated application of transaction processor 130 or other entity (e.g., a merchant), which may be configured to assist in processing transactions electronically.

In various embodiments, client device 110 includes other applications 114 as may be desired in particular embodiments to provide features to client device 110, including those with capturing activities of a user of client device 110 at a particular location. For example, other applications 114 may include security applications for implementing client-side security features, programmatic client applications for interfacing with appropriate application programming interfaces (APIs) over network 140, or other types of applications. Other applications 114 may also include email, texting, voice and IM applications that allow a user to send and receive emails, calls, texts, and other notifications through network 140. Other applications 114 may also include other location detection applications, which may be used to determine a location for client device 110, such as a mapping application. Other applications 114 may include device interface applications and other display modules that may receive input from the user and/or output information to the user. For example, other applications 114 may contain software programs, executable by a processor, including a graphical user interface (GUI) configured to provide an interface to the user. Other applications 114 may therefore use components of client device 110, such as display components capable of displaying information to users and other output components, including speakers.

Client device 110 may further include database 116 stored on a transitory and/or non-transitory memory of client device 110, which may store various applications and data and be utilized during execution of various modules of client device 110. Database 116 may include, for example, identifiers such as operating system registry entries, cookies associated with one or more application, identifiers associated with hardware of client device 110, or other appropriate identifiers, such as identifiers used for payment/user/device authentication or identification, which may be communicated as identifying the user/client device 110 to transaction processor 130. Moreover, database 116 may include received transaction data, including a checkout interface and/or process, as well as data for funds available in one or more digital wallets for the user.

Client device 110 includes at least one network interface component 118 adapted to communicate with wallet provider 120, transaction processor 130, and/or another nearby device within range of network interface component 118. In various embodiments, network interface component 118 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices. Network interface component 118 may communicate directly with nearby devices using wireless communications, such as Bluetooth Low Energy, LTE Direct, WiFi, radio frequency, infrared, Bluetooth, and near field communications.

Wallet provider 120 may be implemented using any appropriate hardware and software configured for wired and/or wireless communication with client device 110, and/or transaction processor 130 for providing digital wallet data for a digital wallet of a user. Wallet provider 120 may correspond to a service provider that may provide services to users, including purchasing or sale of items through a digital wallet having funds held by wallet provider 120. In various embodiments, wallet provider 120 may be implemented as a personal computer (PC), a smart phone, laptop/tablet computer, wristwatch with appropriate computer hardware resources, other type of wearable computing device, and/or other types of computing devices capable of transmitting and/or receiving data. Although only one merchant device is shown, a plurality of merchant devices may function similarly.

Wallet provider 120 of FIG. 1 contains a provider application 122, a database 124, and a network interface component 126. Provider application 122 and other applications 134 may correspond to executable processes, procedures, and/or applications with associated hardware. In other embodiments, wallet provider 120 may include additional or different software as required.

Provider application 122 may correspond to one or more processes to execute modules and associated devices of wallet provider 120 to provide digital wallet services to users, which may be used for processing transactions and may hold a balance of funds. In this regard, provider application 122 may correspond to specialized hardware and/or software utilized by wallet provider 120 to establish an account with a digital wallet by providing personal and/or financial information to wallet provider 120 and selecting authentication credentials. In various embodiments, the financial information may include payment instrument information, such as account/card numbers and information. The digital wallet may be used to send and receive payments, which may include processing transactions on a platform provided by or associated with wallet provider 120. For example, the digital wallet may be used to purchase items, goods, or services from or provided by wallet provider 120. Further the digital wallet me be used to receive payments, including virtual or digital funds from real or virtual cash.

A digital wallet for a user may be identified by an identifier, which may correspond to an alphanumeric identifier that may be shared with transaction processor 130 and/or one or more other wallet providers. The identifier may also correspond to identifying information for the user, such as a name, address, phone number, email address, or the like. Provider application 122 may also include one or more APIs, which may be exposed to transaction processor 130 to allow transaction processor 130 to make API calls to send and receive data. The APIs may allow transaction processor 130 to query provider application 122 to determine digital wallet data stored to database 124, which may include amounts of funds held by one or more digital wallets. Further, the APIs may also allow transaction processor 130 to request a payout and transfer of funds held to the digital wallet. When the payout is requested, provider application 122 may also update the digital wallet with wallet provider 120 when the funds are requested to be transferred so that the user may not further use the funds from the digital wallet of wallet provider 120. This may occur at substantially the same time as funds are provided from an account of wallet provider 120 to an account and/or digital wallet of the user with transaction processor 130.

Wallet provider 120 may further include database 124 which may include, for example, identifiers such as operating system registry entries, cookies associated with provider application 122 and/or other applications 134, identifiers associated with hardware of wallet provider 120, or other appropriate identifiers. Identifiers in database 124 may be used by a payment/service provider to associate wallet provider 120 with a particular account maintained by the payment/service provider. Database 124 may also further store digital wallet data for the digital wallet, including amounts or values of virtual funds held by the digital wallets of wallet provider 120.

Wallet provider 120 includes at least one network interface component 126 adapted to communicate with client device 110 and/or transaction processor 130 over network 140. In various embodiments, network interface component 126 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Transaction processor 130 may be maintained, for example, by an online service provider, which may provide processes to allow users to utilize funds in separate digital wallets for transactions, as well as transaction processing services for those transactions. In this regard, transaction processor 130 includes one or more processing applications which may be configured to interact with client device 110, wallet provider 120, and/or another device/server to facilitate communications and transactions between users based on data captured of the users. In one example, transaction processor 130 may be provided by PAYPAL®, Inc. of San Jose, Calif., USA. However, in other embodiments, transaction processor 130 may be maintained by or include another type of service provider.

Transaction processor 130 of FIG. 1 includes a transaction processing application 132, other applications 134, a database 136, and a network interface component 138. Transaction processing application 132, and other applications 134 may correspond to executable processes, procedures, and/or applications with associated hardware. In other embodiments, transaction processor 130 may include additional or different modules having specialized hardware and/or software as required.

Transaction processing application 132 may correspond to one or more processes to execute modules and associated specialized hardware of transaction processor 130 to process a transaction for item(s) using an account and corresponding digital wallet of a user with transaction processor 130, which may include utilizing funds in a separate digital wallet with wallet provider 120. In this regard, transaction processing application 132 may correspond to specialized hardware and/or software used by a user associated with client device 110 to establish a payment account with transaction processing application 132 by providing personal and/or financial information to transaction processor 130 and selecting authentication credentials. In various embodiments, the financial information may include payment instrument information, such as account/card numbers and information. The account may be used to send and receive payments. The payment account may be accessed and/or used through a browser application and/or dedicated payment application executed by client device 110, such as payment application 112. A digital wallet may be generated for the account that may store the financial information and/or value of funds for a user, where the digital wallet may be identified and utilized using a token.

In some embodiments, transaction processing application 132 may generate and/or receive transaction data for one or more items, and may communicate with client device 110 to process this transaction. This may include providing a checkout webpage or interface where a user may complete electronic transaction processing for an item. The checkout interface may include an option that allows for the user to digital wallet funds in a separate external digital wallet of the user with wallet provider 120 for processing the transaction and providing a payment. Thus, transaction processing application 132 may interact with client device 110 and/or wallet provider 120 (e.g., through one or more API calls to APIs of transaction processing application 132 that interfaces with APIs of client device 110 and/or wallet provider 120). Wallet provider 120 may previously expose an API to transaction processing application 132, which allows transaction processing application 132 to transmit an API call requesting the status and balance of the funds in the external digital wallet with wallet provider 120. Transaction processing application 132 may receive the data and may refresh the checkout interface with the data, which may be done automatically.

The user may then wish to utilize the funds from the external digital wallet with wallet provider 120 to process the transaction and provide a payment to a merchant. In order to utilize the funds from the external digital wallet immediately, transaction processing application 132 may then determine an account internally provided by transaction processor 130 to wallet provider 120. This account may include a balance of funds for wallet provider 120. The amount of the funds for the external digital wallet of the user may be deducted or removed from this balance of wallet provider 120 in the account, and may then be provided to the user's digital wallet with transaction processor 130. This digital wallet may then have an increased balance based on the additional funds available in the external digital wallet. In order to prevent fraud or usage of these digital wallet funds held by wallet provider 120, the API of transaction processing application 132 may then request via the exposed API, a payout or transfer of these funds from wallet provider 120. With this request, wallet provider 120 may also make those funds unavailable to the user, which may occur substantially at the same time as the transfer from the internal account, so that the funds are not available multiple times in multiple accounts or digital wallets. Transaction processing application 132 may receive the acceptance of the transaction and may complete electronic transaction processing for the transaction. Transaction processing application 132 may receive a payment request from client device 110 for the transaction data, which may include identifiers, tokens, or other data used for transaction processing. Transaction processing application 132 may process a payment and may provide a transaction history to client device 110 and/or wallet provider 120 for transaction authorization, approval, or denial and documentation of the user of the funds from the external digital wallet.

In various embodiments, transaction processor 130 includes other applications 134 as may be desired in particular embodiments to provide features to transaction processor 130. For example, other applications 134 may include security applications for implementing server-side security features, programmatic client applications for interfacing with appropriate application programming interfaces (APIs) over network 140, or other types of applications. Other applications 134 may contain software programs, executable by a processor, including a graphical user interface (GUI), configured to provide an interface to the user when accessing transaction processor 130, where the user or other users may interact with the GUI to more easily view and communicate information. In various embodiments, other applications 134 may include additional connection and/or communication applications, which may be utilized to communicate information to over network 140.

Additionally, transaction processor 130 includes database 136. Database 136 may store various identifiers associated with client device 110. Database 136 may also store account data, including payment instruments and authentication credentials, as well as transaction processing histories and data for processed transactions. Database 136 may store received data associated with a user, such as digital wallet data for one or more digital wallets and balances of those digital wallets. Accounting information, ledgers, and payout requests based on interactions with external wallet providers may also be stored to database 136.

In various embodiments, transaction processor 130 includes at least one network interface component 138 adapted to communicate client device 110, wallet provider 120, and/or another device/server for a merchant over network 140. In various embodiments, network interface component 138 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Network 140 may be implemented as a single network or a combination of multiple networks. For example, in various embodiments, network 140 may include the Internet or one or more intranets, landline networks, wireless networks, and/or other appropriate types of networks. Thus, network 140 may correspond to small scale communication networks, such as a private or local area network, or a larger scale network, such as a wide area network or the Internet, accessible by the various components of system 100.

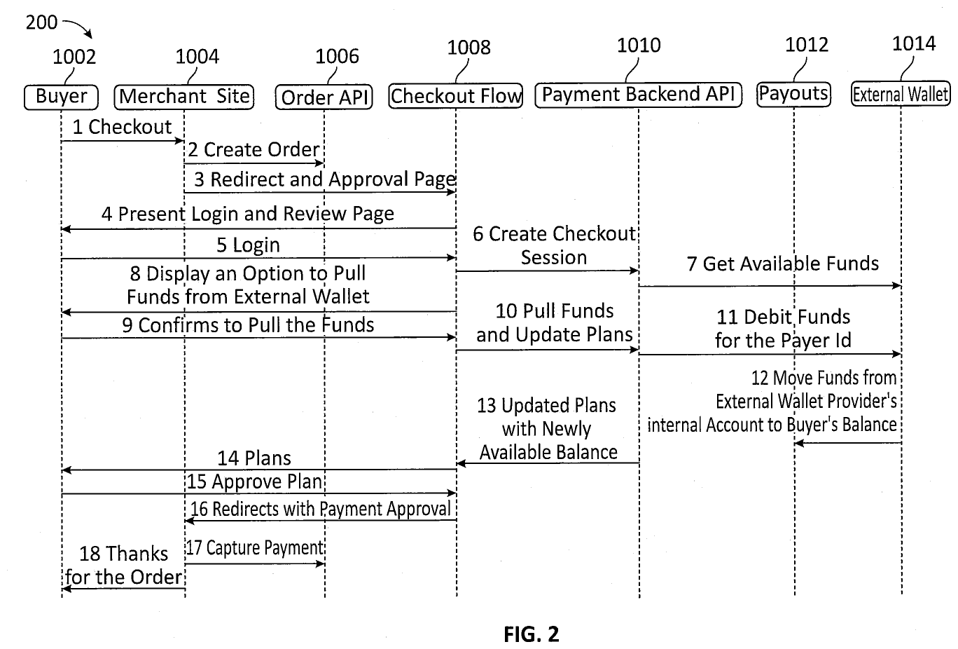

FIG. 2 is an exemplary data processing flow between different platforms for integration of transaction processor system identifiers with digital account providers, according to an embodiment. Environment 200 of FIG. 2 includes a buyer 1002 and an external wallet 1014, which may correspond to entities utilizing client device 110 and wallet provider 120, respectively, discussed in reference to system 100 of FIG. 1. Moreover, one or more of the components of an order API 1006, a checkout flow 1008, a payment backend API 1010, and a payout 1012 may be provided by transaction processor 130 in system 100.

In this regard, buyer 1002 may utilize a device to engage with a merchant site 1004, such as a website of a merchant or other interface, portal, or platform that may be accessible for the user to conduct electronic transaction processing, including in-store transaction processing. Once a transaction is identified and/or generated, the user may navigate to a checkout page or interface, where at step 1, a checkout is requested, such as with transaction processor 130. This may be done through a transaction with merchant site 1004. Thereafter, at step 2, an order is created between merchant site 1004 and order API 1006, which may be provided by transaction processor 130. The order may correspond to providing data necessary for electronic transaction processing of one or more items with merchant site 1004. Merchant site 1004 may then redirect buyer 1002 to checkout flow 1008, at step 3, which may correspond to an API used to guide buyer 1002 through a checkout for one or more items on merchant site 1004 using checkout flow 1008.

Checkout flow 1008 may then present a login and review page to buyer 1002, at step 4, when buyer 1002 is redirected to checkout flow 1008's API and processes. At step 5, buyer 1002 may perform a login with checkout flow 1008, such as by providing an account name, identifier, password, PIN, or other information. This information may correspond to an account of the user, which may include a digital wallet having one or more funding instruments. Checkout flow 1008 may then create a checkout session, at step 6, using the account and data provided for the checkout by buyer 1002 and merchant site 1004. This checkout session is created between checkout flow 1008 and payment backend API 1010, which may be provided by transaction processor 130. Payment backend API 1010 may correspond to a backend transaction processing application and API that allows for account balance processing, use of external payment processors, negotiation of security mechanisms, accounting, and other processes to perform electronic transaction processing. Moreover, payment backend API 1010 may also interact with an exposed API of external wallet 1014 in order to retrieve external wallet balances and request payouts 1012 to retrieve funds from external digital wallets. This may be done through API calls and shared identifiers that allow for identification of the external digital wallets.

Thus, at step 7, available funds are retrieved from external wallet 1014 by payment backend API 1010. The available funds are retrieved by utilizing a shared or universal identifier, such as a payer identifier that identifies multiple wallets and may be shared between different service or digital wallet providers. Payment backend API 1010 may then interface with checkout flow 1008 to provide this data to buyer 1002, where checkout flow 1008 displays an option to pull funds from the external wallet, at step 8. Checkout flow 1008 may automatically refresh a checkout webpage or interface with the available funds from the external wallet for buyer 1002, where buyer 1002 is then able to view what funds, along with any restrictions, may be pulled from which external digital wallets. When refreshed automatically, buyer 1002 is not required to refresh the checkout page, enter additional input, or navigate to a new page or interface. If buyer 1002 wishes to utilize some or all of the funds in the external digital wallet, at step 9, buyer 1002 may confirm to pull the funds from the external digital wallet with checkout flow 1008. Checkout flow 1008 may therefore receive an acceptance or request for the funds from buyer 1002. Checkout flow 1008 then, at step 10, pulls the funds from payment backend API 1010. This may include requesting the funds from an internal account of external wallet 1014 with transaction processor 130.

At step 11, the payer identifier or other universal identifier is used to request transfer of the amount of the funds from external wallet 1014 by payment backend API 1010. For example, transaction processor 130 may provide an internal account that includes a balance of external wallet 1014. The funds are provided from the internal account to the digital wallet of buyer 1002 so that buyer 1002 may use the funds with the checkout between buyer 1002 and merchant site 1004. Thereafter, the funds are moved from the external wallet provider's internal account to the buyer's balance, where payouts 1012 may detect the payout request and update external wallet 1014 with the payout request, at step 12. Step 12 may further include notifying external wallet 1014 of the transfer of the funds, payout request, and other information so that external wallet 1014 updates buyer 1002's external digital wallet to reflect the debit. This may be done substantially at the same time so that external wallet 1014 is informed of the debit or payout request and external wallet 1014 updates the buyer's external wallet of the debit to prevent other use of those corresponding funds again with external wallet 1014. Thus, buyer 1002 may then receive the corresponding amount of funds in their personal digital wallet.

Plans are then updated with the newly available balance by payment backend API 1010 with checkout flow 1008. Checkout flow 1008 may output the plans and available funds, at step 14, to buyer 1002. Buyer 1002 may then see the newly available funds, which may be automatically refreshed in a checkout interface so that the user is not required to perform additional navigations to view the newly available balance. At step 15, buyer 1002 approves the plans, such as use of the new balance of buyer 1002's digital wallet, with checkout flow 1008. This may further include approving electronic transaction processing for the transaction. At step 16, checkout flow 1008 interfaces with merchant site 1004 to redirected merchant site 1004 to a payment approval based on processing the transaction. Merchant site 1004 captures a payment with order API 1006, at step 17, and then further outputs an order confirmation and approval to buyer 1002, at step 18.

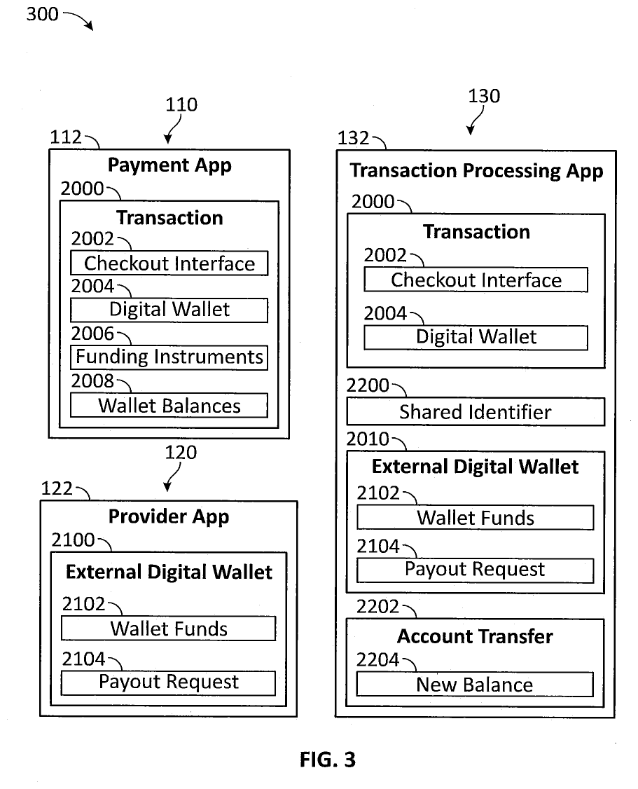

FIG. 3 is an exemplary system environment where a client device interacts with a merchant device and service provider server for integration of transaction processor system identifiers with digital account providers, according to an embodiment. System 300 of FIG. 3 includes client device 110, wallet provider 120, and transaction processor 130 discussed in reference to system 100 of FIG. 1.

Client device 110 executes payment application 112 used to communicate with wallet provider 120 and transaction processor 130 for use in utilizing external digital wallets for transaction processing, discussed in reference to system 100. In this regard, payment application 112 includes data for a transaction 2000 that may be processed through client device 110, where transaction 2000 may include transaction data that may be processed by transaction processor 130. Transaction processor 130 may provide payment application 112 with a checkout interface 2002 that may display the transaction data, as well as digital wallet data used to process the transaction using a funding instrument. In this regard, checkout interface 2002 may include data for a digital wallet 2004 of the user corresponding to client device 110, such as a universal digital wallet that allows for use of multiple different funding sources from different digital wallets. Thus, digital wallet 2004 includes funding instruments 2006 and wallet balances 2008, where wallet balances 2008 may display data for other external digital wallets (e.g., one provided by wallet provider 120).

In this regard, wallet provider 120 executes provider application 122 used to communicate with client device 110 to provide data for external digital wallets that may include balances used during electronic transaction processing, discussed in reference to system 100. Provider application 122 provides data for digital wallets to transaction processor 130, which may be used to update payment application 112 with available balances, as well as request payouts from wallet provider 120. For example, provider application 122 processes and provides data for an external digital wallet 2100, which includes wallet funds 2102 that may be transferred using a payout request 2104. External digital wallet 2100 corresponds to a different digital wallet than the one with transaction processor 130 for the user of client device 110. Moreover, external digital wallet 2100 may be identified using a shared identifier for one or more digital wallets or accounts, where transaction processor 130 may also store the shared identifier.

Transaction processor 130 executes transaction processing application 132 used to communicate with client device 110 and wallet provider 120 to provide a universal digital wallet, discussed in reference to system 100. Transaction processing application 132 may include data for transaction 2000 being processed by client device 110 with a merchant and/or merchant website. Transaction processing application 132 may be used to provide a checkout interface 2002 to client device 110, which includes digital wallet 2004 for the user with transaction processor 130. Digital wallet 2004 may be identified using shared identifier 2200, which may also be used to identify external digital wallet 2100 with wallet provider 120. Thus, transaction processing application 132 may identify external digital wallet 2100 using shared identifier 2200. Wallet funds 2102 may be used to populate such data within payment application 112, where transaction processing application 132 may further process a payout request 2104 for wallet funds 2102. When processing payout request 2104, an account transfer 2202 may transfer the amount of the funds to digital wallet 2004 for wallet funds 21102. A new balance 2204 may be provided for digital wallet 2004 based on the wallet funds 2102 from external digital wallet 2010.

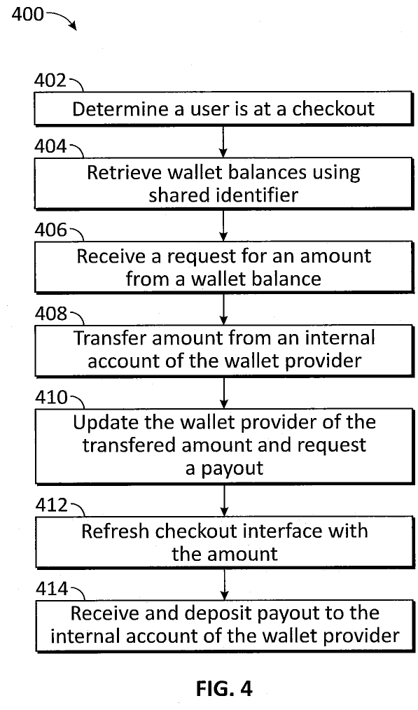

FIG. 4 is a flowchart of an exemplary process for integration of transaction processor system identifiers with digital account providers, according to an embodiment. Note that one or more steps, processes, and methods described herein of flowchart 400 may be omitted, performed in a different sequence, or combined as desired or appropriate.

At step 402 of flowchart 400, it is determined that a user is at a checkout, for example, by a transaction processing system. For example, a user may navigate to a checkout webpage or interface when performing electronic transaction processing. This may be done when the user is ready to checkout and complete a purchase of one or more items with a merchant and may correspond to an interface on an application of a device that may be used to provide a payment through a digital wallet. For example, the user may enter a login and view funding instruments for the payment with the digital wallet. However, the user may lack of an available account balance to complete processing for the transaction or may wish to pay for the transaction using a digital wallet of another service provider. Thus, at step 404, wallet balances are retrieved using a shared identifier, where the wallet balance may correspond to other external digital wallets with wallet providers different than the transaction processing providing the universal digital wallet to the user. These wallet balances may be retrieved using the shared identifier that allows for identification of the external digital wallets on the other wallet provider platforms. Moreover, an API integration with an exposed API of the wallet provider platforms by a checkout flow and/or backend payment API of the transaction processor may provide the integrations for data sharing between the different platforms.

At step 406, a request for an amount from a wallet balance is received. For example, during the checkout process within the checkout interface, the user may request that one or more of the wallet balances be used for the transaction processing and/or their balance(s) moved to the user's universal digital wallet balance with the transaction processor. The amount may correspond to the entire amount of the funds in the external digital wallet or a subset of that amount (e.g., the amount necessary to pay for the transaction using funds currently available with the universal digital wallet). In response to receiving the request, the amount is transferred from an internal account of the wallet provider to the universal digital wallet for the user so that the funds are immediately available to the user. By transferring between balances with the transaction processor, the transaction processor does not have to await delays on fund deposits normally required when moving funds between separate service providers and/or financial institutions.

In order to provide the funds back to the internal account of the external wallet provider so that provider is made whole again, the transaction processor initiates a process to notify the external wallet provider that the funds have been requested and requests a payout of the funds from the external wallet provider. At step 410, the wallet provider is updated of the transferred amount and a payout is requested by the transaction processor. This may occur substantially with step 408 (e.g., at the same time or with a similar time period), which causes the user to immediately have the funds from the external digital wallet available in their universal digital wallet with the transaction processor, while the external wallet provider further updates their database records of the payout request and transfer of funds. Thereafter, at step 412, the checkout interface is refreshed with the amount of funds now available in the user's digital wallet with the transaction processor. This allows the user to utilize the digital wallet to process a transaction with the merchant in the checkout interface. A deposit payout to the interval account of the wallet provider is received at step 414. This deposit payout is from the external digital wallet of the user and serves to replace the transferred funds from the wallet provider's internal wallet. Thus, this makes the external wallet provider's account with the transaction processor whole for the previous transfer of funds.

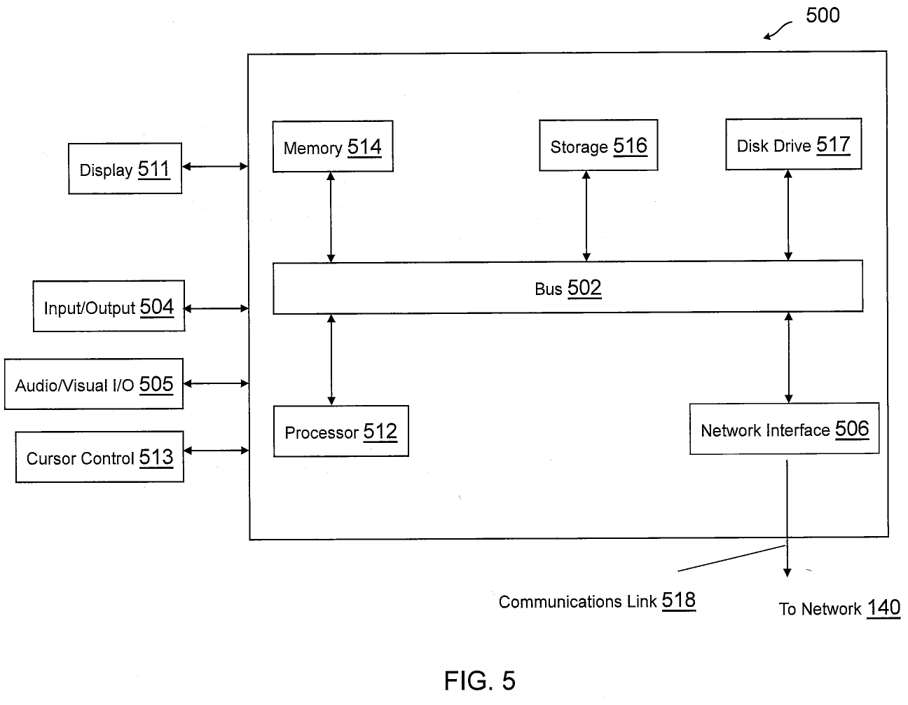

FIG. 5 is a block diagram of a computer system suitable for implementing one or more components in FIG. 1, according to an embodiment. In various embodiments, the communication device may comprise a personal computing device (e.g., smart phone, a computing tablet, a personal computer, laptop, a wearable computing device such as glasses or a watch, Bluetooth device, key FOB, badge, etc.) capable of communicating with the network. The service provider may utilize a network computing device (e.g., a network server) capable of communicating with the network. It should be appreciated that each of the devices utilized by users and service providers may be implemented as computer system 500 in a manner as follows.

Computer system 500 includes a bus 502 or other communication mechanism for communicating information data, signals, and information between various components of computer system 500. Components include an input/output (I/O) component 504 that processes a user action, such as selecting keys from a keypad/keyboard, selecting one or more buttons, image, or links, and/or moving one or more images, etc., and sends a corresponding signal to bus 502. I/O component 504 may also include an output component, such as a display 511 and a cursor control 513 (such as a keyboard, keypad, mouse, etc.). An optional audio input/output component 505 may also be included to allow a user to use voice for inputting information by converting audio signals. Audio I/O component 505 may allow the user to hear audio. A transceiver or network interface 506 transmits and receives signals between computer system 500 and other devices, such as another communication device, service device, or a service provider server via network 140. In one embodiment, the transmission is wireless, although other transmission mediums and methods may also be suitable. One or more processors 512, which can be a micro-controller, digital signal processor (DSP), or other processing component, processes these various signals, such as for display on computer system 500 or transmission to other devices via a communication link 518. Processor(s) 512 may also control transmission of information, such as cookies or IP addresses, to other devices.

Components of computer system 500 also include a system memory component 514 (e.g., RAM), a static storage component 516 (e.g., ROM), and/or a disk drive 517. Computer system 500 performs specific operations by processor(s) 512 and other components by executing one or more sequences of instructions contained in system memory component 514. Logic may be encoded in a computer readable medium, which may refer to any medium that participates in providing instructions to processor(s) 512 for execution. Such a medium may take many forms, including but not limited to, non-volatile media, volatile media, and transmission media. In various embodiments, non-volatile media includes optical or magnetic disks, volatile media includes dynamic memory, such as system memory component 514, and transmission media includes coaxial cables, copper wire, and fiber optics, including wires that comprise bus 502. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 500. In various other embodiments of the present disclosure, a plurality of computer systems 500 coupled by communication link 518 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A transaction processor system comprising:
a non-transitory memory; and
one or more hardware processors coupled to the non-transitory memory and configured to read instructions from the non-transitory memory to cause the transaction processor system to perform operations comprising:
receiving, from a computing device of a user, a wallet balance request for a first digital wallet of the user with a first digital wallet provider separate from the transaction processor system, wherein the wallet balance request is received via a checkout interface of the computing device for an electronic transaction between the user and a merchant;
fetching, via a first application programming interface (API) of the first digital wallet provider, first balance data for the first digital wallet using an identifier of the user with the transaction processor system, wherein first balance data comprises first funds available in the first digital wallet with the first digital wallet provider;
providing the first balance data for display to the user through the checkout interface of the computing device;
receiving a payment request to the merchant for at least a portion of the first funds for the electronic transaction; and
updating a balance of a user account of the user with the transaction processor system with the at least the portion of the first funds using a partner account of the first digital wallet provider provided internally by the transaction processor system.

2. The transaction processor system of claim 1, wherein prior to the updating the balance, the operations further comprise:
requesting, via the first API, the at least the portion of the first funds from the first digital wallet provider; and
providing the at least the portion of the first funds to the partner account of the first digital wallet provider.

3. The transaction processor system of claim 2, wherein the operations further comprise:
processing the electronic transaction using the balance of the user account, wherein the at least the portion of the first funds are used for the electronic transaction.

4. The transaction processor system of claim 2, wherein the updating and the requesting are performed at a same time.

5. The transaction processor system of claim 2, wherein the operations further comprise:
transmitting a notification associated with the updating to the first digital wallet provider, wherein the notification requests that the at least the portion of the first funds are withdrawn from the first digital wallet.

6. The transaction processor system of claim 1, wherein the checkout interface comprises a display of a plurality of digital wallet providers including the first digital wallet provider that are linked to the user account, and wherein the providing the first balance data comprises automatically refreshing the checkout interface with the first balance data without user input or user interface navigation.

7. The transaction processor system of claim 1, wherein the wallet balance request is further for a second digital wallet of the user with a second digital wallet provider separate from the transaction processor system, and wherein the operations further comprise:
fetching, via a second (API) of the second digital wallet provider, second balance data for the second digital wallet using the identifier of the user with the transaction processor system, wherein second balance data comprises second funds available in the second digital wallet with the second digital wallet provider,
wherein the providing the first balance data for display further comprises the second balance data.

8. The transaction processor system of claim 1, wherein the identifier is universal for user account identification or digital wallet identification for the transaction processor system and the first digital wallet provider.

9. The transaction processor system of claim 1, wherein prior to the receiving the wallet balance request, the operations further comprise:
receiving a request to establish the electronic transaction between the user and the merchant; and
providing the checkout interface to the computing device of the user for the electronic transaction.

10. The transaction processor system of claim 1, wherein the first digital wallet provider comprises a partner service provider platform, and wherein the first API of the partner service provider platform is exposed to at least one transaction processor API of the transaction processor system that uses the identifier.

11. The transaction processor system of claim 1, wherein the first funds for the first balance data comprise one of an available cash of the user, virtual cash of the user, or a virtual currency for the first digital wallet provider.

12. A method comprising:
receiving, by a first service provider from a device of a user, a balance query for a digital wallet with a second service provider, wherein the balance query is associated with an account of the user with the first service provider;
determining, via an application programming interface (API) of the second service provider, a digital wallet balance for funds in the digital wallet with the first service provider using a shared wallet identifier for the user with the first service provider and the second service provider; and
causing the digital wallet balance to be displayed via a user interface for the account on the device.

13. The method of claim 12, further comprising:
receiving, by the first service provider, a processing request for a digital transaction between the user and a merchant using at least the funds from the digital wallet;
retrieving an amount for the funds from an internal partner account of the second service provider with the first service provider based on the processing request;
providing the amount of the funds to the account of the user with the first service provider; and
processing the digital transaction using at least the amount of the funds in the account of the user.

14. The method of claim 13, wherein prior to the receiving the balance query, the method further comprises:
generating the digital transaction between the user and the merchant based on transaction data provided by one of the user or the merchant,
wherein the balance query is received in response to the generating the digital transaction.

15. The method of claim 13, further comprising:
requesting, via the API using the shared wallet identifier, the funds from the digital wallet with the second service provider; and
providing the funds to the internal partner account of the second service provider.

16. The method of claim 15, wherein the retrieving, the requesting, and the providing the funds to the internal partner account occur substantially in real-time through the API of the second service provider.

17. A non-transitory machine-readable medium having stored thereon machine-readable instructions executable to cause a machine to perform operations comprising:
updating, in a user interface for an account of a user with a first service provider, an external wallet balance for a digital wallet of the user with a second service provider using a user identifier for the user with the first service provider, wherein the user identifier is shared with the second service provider for user identification of the user, and wherein the account is provided to the user;
receiving a transaction processing request for a transaction with a merchant using the external wallet balance with the account;
transferring the external wallet balance to the account of the user from a service provider account of the second service provider provided by the first service provider to the second service provider;
requesting, via an application programming interface (API) of the second service provider, a transfer of the external wallet balance from the digital wallet of the user to the service provider account of the second service provider; and
processing, based on the transaction processing request, the transaction using at least the external wallet balance in the account.

18. The non-transitory machine-readable medium of claim 17, wherein prior to updating the external wallet balance, the operations further comprise:
receiving, from the user via the user interface, a request to view the external wallet balance with the account; and
accessing, via the API using the user identifier, the external wallet balance from the second service provider.

19. The non-transitory machine-readable medium of claim 17, wherein the transferring and requesting are performed within a time period, and wherein the processing the transaction occurs after the time period.

20. The non-transitory machine-readable medium of claim 17, wherein the transaction comprises an amount more than the external wallet balance, and wherein the processing the transaction comprises using the external wallet balance to first provide a portion of the amount and using an account balance of the account to next provide a remaining portion of the amount.
